(19) United States
(12) Patent Application Publication
(10) Pub. No.: US 2026/0360693 A1
(43) Pub. Date: Nov. 12, 2026

(54) A Method for Rolling Electrode

(71) Applicant: LG Energy Solution, Ltd., Seoul (KR)

(72) Inventors: Min Ki Kim, Daejeon (KR); Beom Su Kim, Daejeon (KR); Nak Won Choi, Daejeon (KR); Youngwan Song, Daejeon (KR); Sang Hoon Choy, Daejeon (KR); Jeong Soo Seol, Daejeon (KR); Keum Yong Park, Daejeon (KR)

(73) Assignee: LG Energy Solution, Ltd., Seoul (KR)

(21) Appl. No.: 19/127,931

(22) PCT Filed: Nov. 24, 2023
(86) PCT No.: PCT/KR2023/019155

§ 371 Date: May 7, 2025

(30) Foreign Application Priority Data
Dec. 23, 2022 (KR) 10-2022-0183576
Mar. 2, 2023 (KR) 10-2023-0027508

(51) Int. Cl. H01M 4/04; G01K 13/06; H01M 4/02

(52) U.S. Cl. CPC H01M 4/0435; G01K 13/06; H01M 2004/021

(57) ABSTRACT

A method for rolling an electrode may include (a) measuring the temperature and speed of the rolling roll; (b) deriving a target load value under the measured temperature and speed; and (c) rolling the electrode with the target load value. T the target load value may be a load value for realizing a desired electrode thickness at the time of rolling the electrode.

### CROSS CITATION WITH RELATED APPLICATION(S)

This application is a national phase entry under 35 U.S.C. § 371 of International Application No. PCT/KR2023/019155 filed on Nov. 24, 2023, which claims the benefit of Korean Patent Application No. 10-2022-0183576 filed on Dec. 23, 2022 and Korean Patent Application No. 10-2023-0027508 filed on Mar. 2, 2023 in the Korean Intellectual Property Office, the disclosures of which are incorporated herein by reference in their entirety.

### TECHNICAL FIELD

The present disclosure relates to a method for rolling an electrode, and more specifically, to a method for rolling an electrode that derives a target load for realizing the desired electrode thickness at the time of rolling an electrode.

### BACKGROUND

The secondary battery can be formed by inserting an electrode assembly composed of a cathode plate, an anode plate and a separator into a case, and then sealing the case. A cathode plate or an anode plate (hereinafter, referred to as “electrode plate”) can be configured by coating an active material slurry onto a cathode current collector or an anode current collector to a predetermined thickness, interposing a separator between the cathode current collector and the anode current collector, and winding the plate in a jelly-roll shape many times or laminating it in a plurality of layers to form an electrode assembly.

The manufacturing process of the secondary battery largely includes the electrode process, wherein the electrode process is divided into an active material mixing process, an active material coating process, a rolling process, a slitting process, a winding process, and the like. More specifically, the electrode plate may be formed of a coated portion coated with the active material slurry and an uncoated portion not coated with the active material slurry. A rolling process of rolling the electrode plate can be included so as to increase the adhesiveness between the coated active material slurry and the electrode current collector and increases the volume density of the active material. The rolled electrode plate can be used by passing through a cutter having a certain width after drying and cutting into a predetermined size.

FIGS. 1 to 3 are conceptual diagrams showing a rolling apparatus for explaining an electrode rolling process.

Referring to FIG. 1, a rolling apparatus for rolling an electrode includes a pair of rolling rolls 20 and 30. The thickness of the electrode 10 decreases in a process of passing between the pair of rolling rolls.

When a rolling operation is performed to manufacture a high-density electrode 10, the force (linear pressure) with which the electrode 10 tries to spread the two rolling rolls 20 and 30 is large, which causes bending of the rolls as shown in FIG. 2. Due to this bending deformation of the rolling rolls 20 and 30, the manufactured electrode 10 is formed thicker at the center of the width than at both side edges, which causes quality defects. In order to solve the thickness deviation in this rolling process, back pressure is applied to both ends of the rolling rolls 20 and 30 to suppress bending as shown in FIG. 3.

Meanwhile, according to the prior art, after test-rolling the electrode 10, the thickness of the electrode 10 is measured, and if the desired thickness is not achieved, the steps of adjusting the gap between the rolling rolls 20 and 30, rolling the electrode and measuring the rolled electrode are repeated until the desired thickness of the appropriate electrode 10 is achieved in the rolling process.

### Technical Problem

It is an object of the present disclosure to provide a method for rolling an electrode so that the desired electrode thickness can be achieved more efficiently in the electrode rolling process.

However, the technical problems to be solved by aspects of the present disclosure are not limited to the above-described problems, and can be variously expanded within the scope of the technical idea included in the present disclosure.

### Technical Solution

According to one aspect of the present disclosure, there is provided a method for rolling an electrode, comprising the steps of: (a) measuring the temperature and speed of the rolling roll; (b) deriving a target load value under the measured temperature and speed; and (c) rolling the electrode with the target load value, wherein the target load value is a load value for realizing a desired electrode thickness at the time of rolling the electrode.

In the step (b) of deriving a target load value under the measured temperature and speed, the target load value may be a value that is previously set by setting each of the temperature and speed as variables.

The target load value may be a value that is previously set by adding multiplication of the temperature and speed as additional variables to the value derived using each of the temperature and speed as variables.

The target load value may be derived by further adding a previously set constant.

The target load value may be derived by substituting the measured temperature and speed into a relationship equation that is previously set by setting each of the temperature and speed as variables.

The relationship equation may have multiplication of the temperature and speed as additional variables.

The relationship equation may further have addition of a previously set constant.

The relationship equation may follow the following Mathematical Equation 1,

$${P}_{1} = W \times ( {C}_{1} \times V + {C}_{2} \times T + {C}_{3} \times V \times T + {C}_{4} ) \qquad [ Mathematical Equation 1 ]$$

wherein, P₁ is the target load value, W is the electrode width, V is the speed, T is the temperature, and C₁, C₂, C₃ and C₄ are coefficients, respectively, which are any one selected from real numbers.

A table is prepared in advance in which temperature and speed are substituted for each section into the Relational Equation, and in the step (b) of deriving a target load value under the measured temperature and speed, the target load value may be derived by substituting the measured temperature and speed into the table, respectively.

The step of deriving a target load value under the measured temperature and speed may comprise summing up load values according to the amount of change in back pressure when there is a change in back pressure.

In the step of summing up load values according to the amount of change in back pressure, a constant may be added as a load value according to the amount of change in back pressure to update the target load value.

The step of summing up load values according to the amount of change in back pressure follows the following Mathematical Equation 2,

$${P}_{2} = {P}_{1} + ( {C}_{5} \times Δ {P}_{b} ) \qquad [ Mathematical Equation 2 ]$$

wherein, P₁ is a target load value according to the temperature and speed, P₂ is a target load value to which a load value according to the amount of change in back pressure is summed up, C₅ is a coefficient, which is any one selected from real numbers, and ΔP_{b} is the amount of change in back pressure.

The step (c) of rolling the electrode with the target load value further comprises test-rolling the electrode with the target load value, wherein when the test-rolled electrode is realized to the desired electrode thickness, rolling of the electrode is normally operated, and wherein when the test-rolled electrode is not realized to the desired electrode thickness, the step (b) may be performed again.

### Advantageous Effects

According to the method for rolling an electrode of the present disclosure, it is possible to prevent repeating the steps of test-rolling the electrode, measuring the thickness of the rolled electrode, and adjusting the gap between the rolling rolls, because the target load at the time of rolling an electrode can be efficiently derived, and the electrode can be rolled with the target load according thereto.

Therefore, the production efficiency of the electrode assembly can be maximized, the productivity can be improved, and the manufacturing costs can be reduced. In addition, the quality of the manufactured electrode assembly can be improved.

Effects obtainable from the present disclosure are not limited to the effects mentioned above, and additional other effects not mentioned herein will be clearly understood from the description of the appended claims by those skilled in the art.

### BRIEF DESCRIPTION OF THE DRAWINGS

FIGS. 1 to 3 are conceptual diagrams showing a rolling apparatus for explaining an electrode rolling process.

FIG. 4 is a flow chart of a method for rolling an electrode according to an aspect of the present disclosure.

FIG. 5 is an example of a table of load values according to rolling temperature and each rolling speed according to an aspect of the present disclosure.

FIG. 6 schematically shows a system (apparatus) for rolling an electrode for realizing a method for rolling an electrode according to an aspect of the present disclosure.

### DETAILED DESCRIPTION

Hereinafter, various aspects of the present disclosure will be described in detail with reference to the accompanying drawings so that those skilled in the art can easily carry out them. The present disclosure may be modified in various different ways, and is not limited to the aspects set forth herein.

A description of portions that are not related to the description will be omitted for clarity, and same reference numerals designate same or like elements throughout the description.

Further, in the drawings, the size and thickness of each element are arbitrarily illustrated for convenience of description, and the present disclosure is not necessarily limited to those illustrated in the drawings. In the drawings, the thickness of layers, areas, etc. are exaggerated for clarity. In the drawings, for convenience of description, the thicknesses of some layers and regions are exaggerated.

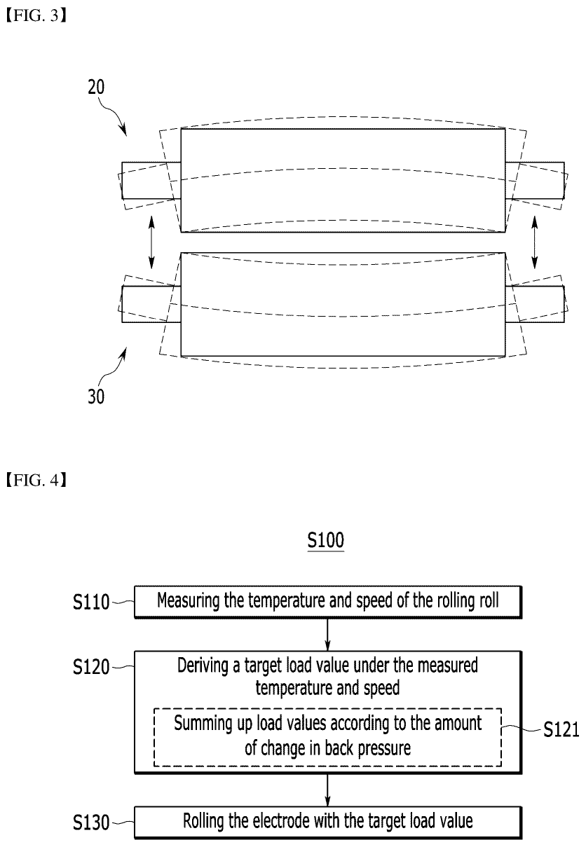

Now, a method for rolling an electrode according to one aspect of the present disclosure will be described with reference to FIG. 4.

FIG. 4 specifically explains a method S100 for rolling an electrode according to an aspect of the present disclosure.

The method S100 for rolling an electrode according to an aspect of the present disclosure comprises a step S110 of measuring the temperature and speed of the rolling roll, a step S120 of deriving a target load value under the measured temperature and speed, and a step S130 of rolling the electrode with the target load value.

The electrode 10 is a sheet-shaped electrode, which may be an electrode for a secondary battery in which an electrode mixture coating layer including an electrode active material, a binder, a conductive material, and a filler is formed on one side or both sides of a current collector.

Even if the rolling rolls 20 and 30 roll the electrode 10 with the same load, the thickness of the rolled electrode 10 varies depending on the speed of the rolling rolls 20 and 30. Therefore, when the speed of the rolling rolls 20 and 30 changes, the load value for making the thickness of the rolled electrode 10 equal (constant) to a desired thickness must also change in accordance therewith.

Similarly, even if the rolling rolls 20 and 30 roll the electrode 10 with the same load, the thickness of the rolled electrode 10 varies depending on the temperature of the rolling rolls 20 and 30. Therefore, when the temperature of the rolling rolls 20 and 30 changes, the load value (target load value) for making the thickness of the rolled electrode 10 equal (constant) to a desired thickness must also be changed in accordance therewith.

Similarly, even if the rolling rolls 20 and 30 roll the electrode 10 with the same load (line pressure), when the back pressure applied to the rolling rolls 20 and 30 changes, the thickness of the rolled electrode 10 also changes. Therefore, when the back pressure of the rolling rolls 20 and 30 changes, the load value (target load value) for making the thickness of the rolled electrode 10 equal (constant) to a desired thickness must also be changed in accordance therewith.

Despite the various process environments, the thickness of the electrode 10 rolled onto the rolling rolls 20 and 30 needs to be formed to be equal (constant) to the desired thickness. According to the present disclosure, among various process environments, in particular, despite changes in the temperature, speed, and/or back pressure of the rolling rolls 20 and 30, a target load value (appropriate load value) for making the thickness of the rolled electrode 10 equal to the desired thickness is derived, and the electrode 10 is rolled with the corresponding target load value.

First, a step (S110) of measuring the temperature and speed of the rolling roll is performed. A temperature sensor (not shown) is provided directly or indirectly on the rolling rolls 20 and 30 to measure the temperature of the rolling rolls 20 and 30. In addition, the speed of the rolling rolls 20 and 30 is, for example, the rotational speed of the rolling rolls 20 and 30. A speed sensor (not shown) may be provided directly or indirectly on the rolling rolls 20 and 30, or may be calculated based on a previously set moving speed of the electrode 10.

Next, a step (S120) of deriving a target load value according to the measured rolling temperature and rolling speed is performed. The temperature of the rolling roll is referred to as the rolling temperature, and the speed of the rolling roll is referred to as the rolling speed. In step S120, the target load value is derived by setting the rolling temperature and rolling speed as variables. In some cases, the target load value may be derived by adding not only the rolling temperature and rolling speed but also multiplication of the rolling temperature and rolling speed.

More specifically, in step S120, for example, the target load value can be derived by substituting the temperature and speed measured in step S110 into a relational equation according to the rolling temperature, the rolling speed, and the target load value obtained by multiplying the rolling temperature and rolling speed. The relational equation according to the rolling temperature, the rolling speed, and the target load value obtained by multiplying the rolling temperature and rolling speed can be represented by the following Mathematical Equation 1. That is, the target load value P₁ follows the following Mathematical Equation 1. In order to distinguish it from the target load value P₂ derived from Mathematical Equation 2, which will be described later, for convenience of explanation, the target load value P₁ derived from the following Mathematical Equation 1 is referred to as the first target load value.

$${P}_{1} = W \times ( {C}_{1} \times V + {C}_{2} \times T + {C}_{3} \times V \times T + {C}_{4} ) \qquad [ Mathematical Equation 1 ]$$

wherein, P₁ is a first target load value, W is the electrode width, V is the rolling speed, T is the rolling temperature, and C₁, C₂, C₃ and C₄ are coefficients, respectively, which are real numbers.

A weight is given to the rolling speed measured in step S110 as a value of C₁ that matches the process environment and the electrode to be manufactured, and similarly, a weight is given to the rolling temperature measured in step S110 as a value of C₂ that matches the process environment and the electrode to be manufactured, thereby summing up these.

In some cases, if the multiplication of the rolling temperature and rolling speed also affects the target load value (first target load value), the weight is also given to the value of C₃ that matches the process environment or electrode to be manufactured, which can be then added. Further, in some cases, C₄ previously set to match the process environment or electrode to be manufactured can be added.

The load value (C₃×V×T) obtained by multiplying the rolling temperature and the rolling speed is a value that can be added when an error occurs or correction is required even if the load value according to the rolling speed (C₁×V) and the load value according to the rolling temperature (C₂×T) are derived as described above. Further, C₄ is also a value that can be added when an error occurs or correction is required. Thereby, the target load can be realized more accurately. Of course, if multiplication of rolling temperature and rolling speed is not required, C₃ may be 0. Further, if correction via C₄ is not required, C₄ may be 0.

Each of C₁, C₂, C₃ and C₄ can be selected in a variety of ways depending on the type of electrode to be manufactured, process environment, and the like. For example, since the type and ratio of the active materials differ depending on the electrode to be manufactured, C₁, C₂, C₃ and C₄ values suitable therefor can be selected. In one example, C₁, C₂, C₃ and C₄ may be 0.0009, −0.0058, 0.00007, and 1.783 in that order, respectively.

Alternatively, in step S120, the target load value (first target load value) corresponding to each rolling temperature and each rolling speed may be derived from the table. A table can be prepared by substituting the rolling temperature into Mathematical Equation 1 for each section, and similarly substituting the rolling speed for each section.

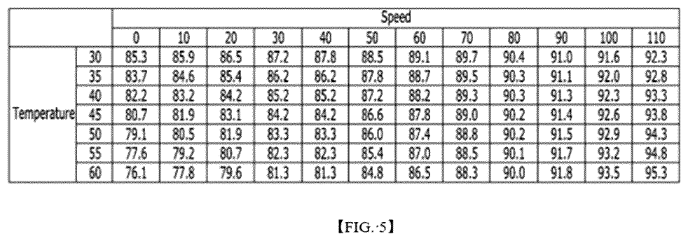

For reference, FIG. 5 is an example of a table of load values according to the rolling temperature and each rolling speed. If C₁, C₂, C₃ and C₄ are, for example, 0.0009, −0.0058, 0.00007, and 1.783 in that order, respectively, as described above, this is a case where the rolling temperature is varied by 5 degrees Celsius in the range of 30 degrees Celsius to 60 degrees Celsius and substituted into Mathematical Equation 1, and the rolling speed is substituted into Mathematical Equation 1 while changing the value by 10 m/s in the range of 0 m/s to 110 m/s, thereby deriving a table.

Step S120 may further comprise a step S121 of summing up load values according to the amount of change in back pressure when there is a change in back pressure. That is, in step S120, only the step of deriving the target load value according to the measured rolling temperature and rolling speed may be performed as described above, however, when the back pressure changes, the target load value is updated and derived by adding the load value according to the change in back pressure. For reference, the case where there is a fluctuation (change) in the back pressure are largely divided into cases where an operator manually adjusts the back pressure and the back pressure fluctuates accordingly, and cases where the back pressure fluctuates due to an automatic correction program to determine the shape of the electrode width direction and then adjust it to the desired shape.

More specifically, for example, the second target load value P₂ can be derived by adding a load value corresponding to the back pressure change according to the following Mathematical Equation 2 to the first target load value P₁ derived from Mathematical Equation 1. That is, the second target load value P₂ follows the following Mathematical Equation 2.

$${P}_{2} = {P}_{1} + ( {C}_{5} \times Δ {P}_{b} ) \qquad [ Mathematical Equation 2 ]$$

wherein, P₁ is a first target load value, P₂ is a second target load value, C₅ is a coefficient, which is any one selected from real numbers, and ΔP_{b} is the amount of change in back pressure. For example, C₅ may vary depending on the specifications of the device (equipment) for rolling the electrode. More specifically, C₅ may be proportional to the value obtained by subtracting the square of the rod diameter from the square of the inner diameter of the back pressure cylinder.

In one exemplary aspect, when the first target load value P₁ is 100, correction can be made so that for every 10 bar of back pressure P_{b}, 8.07 is added to 100, which is the first load value P₁, to derive 108.07, which is the second target load value P₂. At this time, when the back pressure rises by 20 bar, 8.07×2 may be added to the first target load value P₁. In summary, in the exemplary aspect, it is sufficient to multiply the amount of change in back pressure ΔP_{b} by 0.807 per 1 bar and add it to the first target load value P₁.

Next, a step S130 is performed in which the rolling roll rolls the electrode using the target load value derived in step S120. If there is no change in the back pressure of the rolling rolls 20 and 30 in step S120, the electrode 10 may be rolled using the first target load value P₁ derived from Mathematical Equation 1. On the other hand, when there is a change in the back pressure of the rolling rolls 20 and 30, the electrode 10 may be rolled using the second target load value P₂ derived from Mathematical Equation 2 in step S121.

In step S130, if necessary, test rolling may be included with the target load value derived in step S120. When the electrode is realized to the desired thickness through test rolling, the electrode rolling process may be operated normally. However, if the electrode was not realized to the desired thickness during test rolling, the process returns to step S120 and adjust at least one of C₁, C₂, C₃, C₄ and C₅. Thereafter, test rolling may be performed again, or if the test rolling is an adjustment to the extent that it is not required, the electrode rolling process can be operated normally.

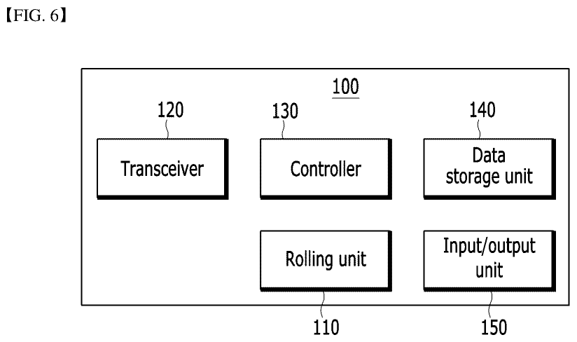

FIG. 6 schematically shows a system (apparatus) for rolling an electrode for realizing a method for rolling an electrode according to an aspect of the present disclosure.

The method of rolling an electrode according to an aspect of the present disclosure can be realized in a system 100 for electrode rolling including a rolling unit 110, a transceiver 120, a controller 130, and an input/output unit 150 as shown in FIG. 6.

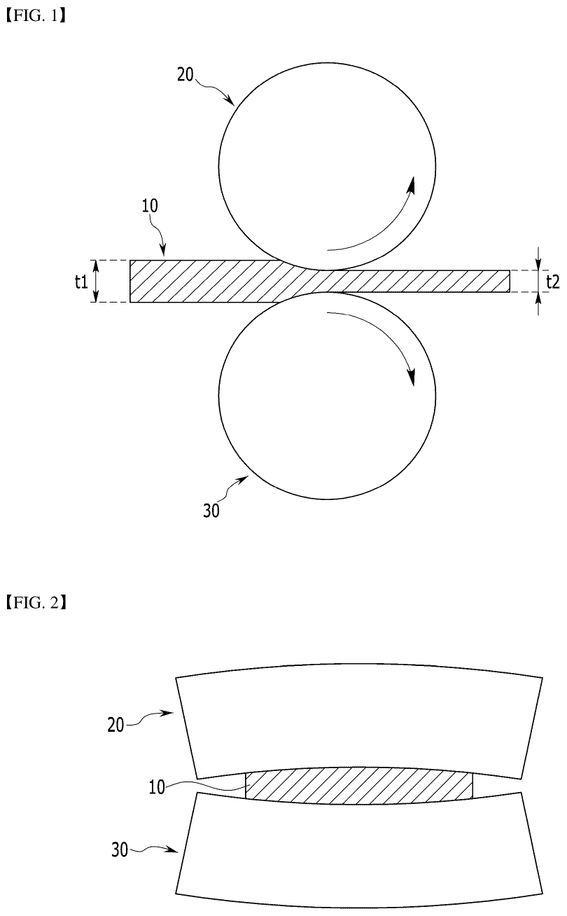

As the rolling unit 110, a rolling apparatus commonly used in the electrode manufacturing process can be used, and therefore, a detailed illustration thereof is omitted. The rolling unit 110 may include rolling rolls 20 and 30 as shown in FIG. 1, a back pressure cylinder (not shown), various sensors (not shown), and the like. The sensor may include a temperature sensor that measures the temperature of the rolling rolls 20 and 30, a speed sensor that measures the moving speed of the electrode or the driving speed of the rolling roll, a thickness gauge that measures the thickness of rolled electrodes (e.g., Maysun thickness gauge), and the like as shown in FIG. 1. The thickness gauge can calculate the thickness of the electrode through changes in the position of the rolling rolls 20 and 30, or can directly measure the thickness of the electrode that has passed through the rolling unit, or may calculate the thickness by sensing the gap between the rolling rolls 20 and 30.

The transceiver 120 receives data transmitted from a sensor provided in the rolling unit 110 or receives data transmitted from an input/output device of an operator and transmits the data to the controller 130. Data transmitted to the controller 130 may include rolling temperature, rolling speed, and/or back pressure change (or reverse pressure) value as described above regarding the method of rolling the electrode. The controller 130 receives data on rolling temperature, rolling speed, and/or back pressure change (or reverse pressure) and derives a target load. The controller 130 derives the target load in conjunction with a data storage unit 140, which is integrated into the electrode rolling system 100 or provided externally. The data storage unit 140 may store various relational equations (Mathematical Equation 1, Mathematical Equation 2) in accordance with the type of electrode to be manufactured and/or for various environments of the process, or may store various tables (e.g., FIG. 5) corresponding to the relevant relational equations. For components related to other devices required for realizing the method for rolling an electrode according to an aspect of the present disclosure, refer to apparatuses used in a typical electrode rolling process.

According to the method of rolling an electrode according to an aspect of the present disclosure, loads can be calculated based on process conditions and rolled thicknesses can be targeted at once without operator intervention, unlike conventional technology in which the operator manually adjusts the rolling process parameters (gap, back pressure), confirms the rolling thickness and then repeat readjustment. Therefore, the efficiency of the electrode manufacturing process is maximized, the productivity is increased, and the manufacturing costs are reduced.

In addition, according to the method of rolling an electrode according to the aspect of the present disclosure, the thickness of the rolled electrode can be realized to be equal (constant) to the desired thickness, thereby equalizing and improving the quality of secondary batteries including electrodes manufactured and significantly lowering the defective rate.

Although the disclosure has been described in detail above with reference to preferred aspects thereof, it will be appreciated by those skilled in the art that the scope of the present disclosure is not limited thereto, and various modifications and improvements can be made in these aspects without departing from the principles and sprit of the disclosure, the scope of which is defined in the appended claims and their equivalents.

### DESCRIPTION OF REFERENCE NUMERALS

10: electrode
20, 30: rolling roll
100: system for electrode rolling
110: rolling unit
120: transceiver
130: controller
140: data storage unit
150: input/output unit

1. A method for rolling an electrode, comprising the steps of:
(a) measuring a temperature and a speed of a rolling roll;
(b) deriving a target load value under the measured temperature and speed; and
(c) rolling an electrode with the target load value,
wherein the target load value is a load value for realizing a desired electrode thickness at a time of rolling the electrode.

2. The method for rolling an electrode according to claim 1, wherein:
in the step of (b) deriving the target load value under the measured temperature and speed,
the target load value is a value that is previously set by setting each of the temperature and the speed as variables.

3. The method for rolling an electrode according to claim 2, wherein:
the target load value is a value that is previously set by adding multiplication of the temperature and the speed as additional variables to the value derived by setting each of the temperature and speed as variables.

4. The method for rolling an electrode according to claim 2, wherein:
the target load value is derived by further adding a previously set constant.

5. The method for rolling an electrode according to claim 1, wherein:
the target load value is derived by substituting the measured temperature and speed into a relationship equation that is previously set by setting each of the temperature and the speed as variables.

6. The method for rolling an electrode according to claim 5, wherein:
the relationship equation has multiplication of the temperature and the speed as additional variables.

7. The method for rolling an electrode according to claim 5, wherein:
the relationship equation further has addition of a previously set constant.

8. The method for rolling an electrode according to claim 5, wherein:
the relationship equation follows the following Mathematical Equation 1,
$${P}_{1} = W \times ( {C}_{1} \times V + {C}_{2} \times T + {C}_{3} \times V \times T + {C}_{4} ) \qquad [ Mathematical Equation 1 ]$$
wherein, P₁ is the target load value, W is an electrode width, V is the speed, T is the temperature, and C₁, C₂, C₃ and C₄ are coefficients comprising real numbers.

9. The method for rolling an electrode according to claim 5, wherein:
a table is prepared in advance in which the temperature and the speed are substituted for each section into the relationship equation, and
wherein in the step of (b) deriving the target load value under the measured temperature and speed, the target load value is derived by substituting the measured temperature and speed into the table, respectively.

10. The method for rolling an electrode according to claim 1, wherein:
the step of (b) deriving the target load value under the measured temperature and speed comprises summing up load values according to an amount of change in a back pressure.

11. The method for rolling an electrode according to claim 10, wherein:
in the summing up the load values according to the amount of change in back pressure, a constant is added as a load value according to the amount of the change in the back pressure to update the target load value.

12. The method for rolling an electrode according to claim 10, wherein:
the summing up the load values according to the amount of the change in the back pressure follows the following Mathematical Equation 2,
$${P}_{2} = {P}_{1} + ( {C}_{5} \times Δ {P}_{b} ) \qquad [ Mathematical Equation 2 ]$$
wherein P₁ is a first target load value according to the temperature and the speed, P₂ is a second target load value to which a load value according to the amount of the change in the back pressure is summed up, C₅ is a coefficient which is a real numbers, and ΔP_{b} is the amount of the change in the back pressure.

13. The method for rolling an electrode according to claim 1, wherein:
the step of (c) rolling the electrode with the target load value further comprises test-rolling the electrode with the target load value,
wherein when the test-rolled electrode is realized to the desired electrode thickness, rolling of the electrode is normally operated, and
wherein when the test-rolled electrode is not realized to the desired electrode thickness, the step (b) is performed again.
